(19) United States
(12) Patent Application Publication
(10) Pub. No.: US 2002/0170962 A1
(43) Pub. Date: Nov. 21, 2002

(54) Subsidizing public transportation through electronic coupons

(75) Inventors: Stefan Besling, San Jose, CA (US); Eric Thelen, Aachen (DE); Meinhard Ullrich, San Jose, CA (US)

Correspondence Address: Michael E. Schmitt, Corporate Patent Counsel, U.S. Philips Corporation, 580 White Plains Road, Tarrytown, NY, 10591, US

(73) Assignee: KONINKLIJKE PHILIPS ELECTRONICS N.V.

(21) Appl. No.: 09/816,012

(22) Filed: Mar. 22, 2001

(51) Int. Cl. G07B 15/02

(52) U.S. Cl. 235/384

(57) ABSTRACT

The transportation costs of a mass transit system are subsidized in the following manner. A person is enabled to use a mass transport system wherein a passenger uses a transportation pass. The pass is also validated for conducting a commercial transaction outside the system. This works as an incentive for people to use the system, and enables to acquire data about the flow of passengers in the system and beyond. Commercial enterprises may benefit from the data collection, and may further subsidize the system by attracting patrons through the pass that can serve as an electronic coupon.

### FIELD OF THE INVENTION

The invention relates to electronic support of commerce and its use to the benefit of a social infrastructure, in particular of aspects relating to public transportation.

### BACKGROUND OF THE INVENTION

Public transportation, i.e., mass transit services, is a necessary part of the infrastructure of any large city. However, providing mass transit service is a very expensive proposition. First, the infrastructure must be put in place, whether in terms of subways, trams or bus lines. Then, the general population has to be encouraged to shift from their previous mode of transportation, e.g., individual transportation, to the newly-installed mass transit services. Many of the “encouragement” schemes involve financial disincentives, e.g., increasing taxes associated with parking, etc. However, there are very few direct, positive incentives for encouraging most individuals to adopt mass public transportation. Moreover, there are many inconveniences associated with riding mass public transportation.

One major inconvenience of mass public transportation is the antiquated methods used in paying for this service. Traditionally, fare collection involved placing money or tokens into the farebox upon boarding the transit vehicle. While simple in nature, this method was time consuming, inconvenient to the user and required labor-intensive, theft-prone money handling activities. The advent of electronic and automated fare payment systems has reduced these high cost transactions by utilizing electronic communication, data processing and data storage techniques in fare collection. These advanced fare payment systems are rapidly replacing the manual methods.

Electronic and automated fare payment systems integrate electronic communication, data processing, data storage and microcomputer technologies in the process of fare collection in subsequent record keeping and funds transfer. These systems may include magnetic fare cards and smart cards with a microprocessor. These technologies reduce the travelers' inconvenience, vehicle delays, and revenue leakage associated with paying cash fares on transit vehicles. In the past decade, transit operators have adopted many advanced technologies in their fare payment system to increase convenience and efficiency.

Electronic Fare Payment Systems generally include two main components. One such component relates to Advanced Fare Payment Systems, which deal with specific fare media, including a variety of fare card types such as stored value fare payment cards, and new hardware devices, e.g., Ticket Reading and Imprinting Machines (TRIM) for handling transactions and transfers. Another component relates to Fare Integration Systems, which deal with the creation of multi-modal and multi-provider transportation networks that link together the fare collection of different operators and modes of transit.

Advances in Fare Integration Systems, made possible by the development of new media and hardware devices, allow fare media that can be used for more than one transit mode, such as magnetic strip cards usable for subways, buses, and passenger ferries. Another type of Fare Integration System is one that links fare collection to consumer financial systems. This allows the use of credit, debit and ATM cards for transit fare payment. The two components, Advanced Fare Payment Systems and Fare Integration Systems, together provide travel that is seamless for the passenger but operationally and financially sound for the multiple operators.

An advanced fare payment system involves an electronic fare media capable of storing fare information in a variety of forms from read-only to read-write forms. These electronic fare media include, e.g., magnetic strip cards and smart cards that contain microprocessors, each with their own respective advantages. The most prevalent and promising options available for today's electronic and automated fare payment systems are as follows:

(1) Magnetic Strip Card—The magnetic strip card uses a magnetic field to communicate. Magnetic strips can be printed on cards ranging from heavy paper to a variety of plastics and they can be coated with a plastic layer for extended life. These cards have been particularly successful in rapid transit systems in the form of readable and writeable cards that require read-write units. These read-write units are installed in turnstiles at each rapid transit station. Inserting the ticket into turnstiles at the beginning and end of a trip allows the read-write unit to deduct the fare according to the length of the trip.

(2) Contact—Type Integrated Circuit Smart Cards—These cards, sold at fixed denominations, contain read-write memory that is hard-wired so the value can be decreased but not increased to prevent the risk of counterfeit. The stored value decreases with use until the card is exhausted and then discarded. These cards also contain Read Only Memory (ROM) that allows for non-alterable bits of information that can be used for identification purposes such as ID cards. IC cards are used for simple applications because they can run on hardwired logic routines and do not require a microcomputer chip.

(3) Capacitively Coupled Cards—Capacitively coupled cards are cards that use capacitive coupling in order to perform read-write functions. This type of card contains two or more areas of metal foil, that are covered by thin layers of a plastic insulator. When the plastic coated metal foil layers are closely aligned with the plastic coated metal foils contained within the read-write unit, a capacitor is created that couples the circuits of the two components. This coupling allows the communication and transfer of information between the card and the read-write unit by supplying the required power and signals.

(4) Proximity Cards (RF Proximity Cards)—Proximity cards do not require direct physical contact between the card and a read-write unit. A typical example is the radio frequency (RF) proximity card. This type of card contains an induction coil that is coupled with the RF magnetic field generated by another induction coil, located in the read-write unit. The RF magnetic field of the unit serves as the power source for the circuits in the card and when modulated, carries signals to the card. The card itself also has the capability of sending signals back to the read-write unit using the same coil or a separate coil or antenna.

RF Proximity cards are currently being used for, e.g., identification purposes for conditional access of buildings. The card need only contain a single identification message that it relays in response to a query given by the reading unit. Such uses of proximity cards require only a ROM memory that can be programmed during manufacturing. Other current uses for RF proximity cards include keyless entry systems, personnel identification and inventory security in offices and retail stores.

Most of the mass transit systems charge users on a distance-traveled basis rather than a flat fee per use, e.g., the fare structure employed in New York City. Thus, information is exchanged between two stations in order to compute the appropriate fare for the distance travel at that time of day, irrespective of how the information is exchanged. With respect to magnetic strip systems, information regarding the passenger's entry into the system can be recorded on the magnetic strip, i.e., the passenger transmits the information for the mass transit system. In the case of RF Proximity cards, the information can be either recorded in the card's memory or the information can be transmitted to a central data base, where the entry and exit information can be employed to bill the passenger for transportation services used by him/her.

Fare integration systems are fare payment systems that are intended to simplify travel and make it more efficient to move between different transit modes and operators. There are three types of integration that are emphasized in today's Fare Integration System. One type involves linking the fare payment systems among different modes of transportation that are managed by a single transit operator. A second type links together different transit operators to the same system of fare payment. A third type of, integration links transit fare payment systems with consumer financial systems such as banks and credit unions. The goal of these mergers is to increase convenience for the passenger and operational effectiveness for the operators.

An Integrated Fare Payment System following universal standards allows efficient linking of multiple providers. There are many benefits that make this cooperative fare payment system appealing. The most significant benefits include the accommodation of more sophisticated fare structures without manual computation, significant decrease in cash transfers, automation of accounting processes, convenience and operational effectiveness. These advances, which mostly require electronic fare media, are realized through technological advances in electronic data processing, communication and storage. Among these advances are new innovations that are strictly designed to accommodate Fare Integration Systems. Integrated Fare Payment Systems generally fall into one of the following categories:

(1) Transit Passes—Transit passes, often read-only magnetic strip cards, do not contain value that is reduced with use, but serve as a pass when inserted into a sensor unit. Transit passes are purchased during issuing periods and are commonly valid for one month. These cards are swiped through reading units at subway turnstiles or electronic fare boxes of buses. The primary benefit of using transit passes is increased convenience and accounting simplifications by minimizing the number of monetary transactions. Monetary transactions can be maximally reduced when the transit pass system is integrated with the financial systems of employers. With the implementation of this integration system, transit passes can be paid for by the employer or via the employer through deduction from wages. This would allow employers to purchase transit passes for all employees in one transaction, and the passenger would be free of all such transactions.

(2) Stored Value Fare Cards—Stored value fare cards contain value for more than one trip and value is deducted from the card with use. Fare media that is appropriate for such use include read-write magnetic strip cards, contact type smart cards and proximity smart cards and all require respective read-write units. Stored value fare cards can serve to decrease the number of monetary transactions by allowing accumulation of value on the card. This option also avoids transaction fees associated with credit card use. These cards record the origin and destination of a trip so that fare-pricing systems can be developed according to time of day and distance traveled.

(3) Fare Systems Based on Passenger Accounts—Integration of the fare payment system with consumer financial systems requires the establishment of passenger accounts that can be billed according to individual transit use. Identification cards are issued and transit use is monitored and recorded by read-only units that recognize valid accounts. Appropriate fare media for this system would only require read-only capabilities and can be fulfilled by bar code cards, magnetic strip cards and RF proximity cards. If origins and destinations are recorded along with fare information, sophisticated fare pricing systems could also be utilized.

(4) Multi-Use Electronic Coin Purses—The multi-use electronic coin purse is a system to integrate transit fare payment with local merchants. These cards, like the stored value fare card, contain value for more than one transit trip but also allow for small purchases from participating merchants. Fare media appropriate for such use requires read-write capabilities and include read-write magnetic strip card or IC smart cards. Current developments in multi-use electronic coin purses involve IC smart cards.

### SUMMARY OF THE INVENTION

As discussed above, there are currently few ways to encourage usage of mass transit systems via positive incentives, other than to offer transportation services as an employee benefit, i.e., to offer employees transportation which is either free or substantially discounted.

The invention provides a method for subsidizing the transportation costs in mass transit systems. The travelers use transportation passes that enable tracking the travelers for the purpose of building a data base. This data base enables extracting information about, e.g., the typical number of users entering or exiting the mass transit system, the geographic areas associated with the entering and exiting, the times of the day, etc. This information is useful for demographic purposes, e.g., it is relevant to traffic controllers, city planners, merchants, police, medical teams, billboard advertisers, ATM banking machines, restaurants and stationary and mobile fast-food suppliers, etc. The passenger flow can be mapped onto a supporting infrastructure to maximize convenience, and the infrastructure itself can be modified to control the flow through the incentives tied to certain locations and in certain time periods. The information is in particular highly relevant to commercial enterprises such as retail stores, restaurants, movie theaters, etc., which can be reached via public transportation. The transportation pass can serve, e.g., as an electronic coupon to support or otherwise facilitate transactions at such commercial enterprises, e.g., by providing a discount on goods or services. Alternatively, or supplementarily, upon a purchase from such local commercial enterprise, the transportation fare gets reimbursed or the transportation pass of the debit-card type gets recharged. Thus, the population is given an incentive to make use of the mass transportation. At the same time, merchants benefit from this link with the transportation system since the number of the merchants' patrons is to increase.

The invention provides a mechanism for resolving the information on mass transit passengers into useful demographic data, which can be packaged and sold to advertisers to further subsidize mass transit costs. The invention also enables to determine how the mass transit passenger spends his/her time outside of the mass transit system, which information could markedly increase the value derived from mass transit passenger or passenger usage data.

Thus the invention resolves mass transit passenger information into highly targeted demographic information which can be resold or leased to merchants in order to defray the cost of mass transit service to the passengers as a whole. The invention also enables to subsidize the mass transit costs of passengers on an individual basis. It is beneficial with respect to both of the above-mentioned aspects if the travel patterns of the mass transit passengers are tracked outside of the mass transit system on a non-intrusive basis. Such tracking would increase the value of demographic information and permit merchants to reward passengers for browsing their establishments.

Based on the above and foregoing, it can be appreciated that there presently exists a need for methods for subsidizing mass transit systems which overcomes the deficiencies mentioned earlier. The present invention is motivated by a desire to overcome the drawbacks and shortcomings of the presently available technology, and thereby fulfill this need in the art.

The objects, features and advantages according to the present invention are provided by a method of subsidizing the transportation costs to a passenger of a mass transit system. Preferably, the method includes steps for recognizing a transportation pass in the vicinity of, but outside of, the mass transit system and providing the passenger with a discount on goods and services.

These and other objects, features and advantages according to the present invention are provided by a method of subsidizing the transportation costs to a passenger of a mass transit system, including steps for recognizing a transportation pass in a predetermined area outside of the mass transit system, and adding electronic cash to the transportation pass.

These and other objects, features and advantages according to the present invention are provided by a method for subsidizing the operation of a mass transit system. Advantageously, the method includes steps for accumulating passenger profiles including identification information while the passengers are traveling on the mass transit system, expanding the accumulated passenger profiles based on the identification information to thereby generate expanded passenger profiles, and extracting saleable data from the expanded passenger profiles, wherein the sale of the saleable data provides funds to offset the operation costs of the mass transit system.

These and other objects, features and advantages according to the present invention are provided by a method for indirectly subsidizing the operation of a mass transit system, including steps for:

(1) accumulating first passenger profiles including identification information while the passengers are traveling on the mass transit system;

(2) accumulating second passenger profiles including identification information while the passengers are outside of the mass transit system;

(3) combining the first and the second passenger profiles into accumulated passenger profiles;

(4) expanding the accumulated passenger profiles based on the identification information to thereby generate expanded passenger profiles; and

(5) extracting saleable data from the expanded passenger profiles. According to one aspect of the invention, the sale of the saleable data provides funds to offset the operation costs of the mass transit system.

Looking at an aspect of the invention from another perspective, smart cards are known that transmit a signal that allows a receiving device to identify the card and thereby, possibly, its owner. The inventors propose to use receiving devices on buses and/or other mass transport systems. In this manner it is possible to determine a profile of a card or its owner regarding the places of interest visited. This information can be combined with the data that indicate the moments in time at which the person entered and exited the mass transport system. This then is representative of the time that the person spent in a geographic area. This information is relevant to the public transport system, e.g., for the purpose of optimizing the use of the available resources. The information is also relevant to retail stores and other commercial enterprises that are accessible through the mass transport system. It is therefore worthwhile to motivate people to wear such smart cards by functionally integrating them with a travel pass or ticket. The fare to be paid by the user can reduced e.g., by having the parties interested in the data subsidize the mass transport system in return for. access to the data. Alternatively, or in addition, the smart card can serve as an electronic purse for use with the mass transport system and/or for shopping in a certain geographic area. For example, each time a user leaves a bus at a certain stop and spends some time in a shopping area until he or she re-enters another bus the electronic money in the card is increased by a certain amount.

### BRIEF DESCRIPTION OF THE DRAWINGS

The invention is described in further detail, and by way of example, with reference to the accompanying drawing, wherein:

FIG. 1 is a schematic diagram of a transportation pass showing use thereof in a normal debit operation;

FIG. 2 is a schematic diagram similar to FIG. 1 showing the operation of the transportation pass when empty;

FIG. 3 is a schematic diagram similar to FIG. 1, showing remote renewal of the transportation pass;

FIG. 4A is a schematic perspective view illustrating the use of the transportation pass when used with a mass transit system while FIG. 4B is a perspective view depicting the use of the transportation pass in a merchants establishment;

FIG. 5 is a flowchart with steps for performing a data resolution operation in a first preferred embodiment of the invention;

FIG. 6 is a flowchart with steps for enhancing the data processed in the method of FIG. 5;

FIG. 7 is a flowchart with steps for subsidizing individual passengers patronizing a participating merchant; and

FIG. 8 is a flowchart with steps for subsidizing individual passengers by treating the transportation pass as a coupon.

Throughout the drawing, same reference signs indicate similar or corresponding features

### DETAILED DESCRIPTION OF THE PREFERRED EMBODIMENTS

While the present invention is described herein with reference to illustrative embodiments for particular applications, it should be understood that the invention is not limited thereto. Those having ordinary skill in the art and access to the teachings provided herein will recognize additional modifications, applications, and embodiments within the scope thereof and additional fields in which the present invention would be of significant utility.

As mentioned above, transportation passes that periodically send a signal which allows receiving devices to identify the pass are known. It will be appreciated that the transportation pass of this type advantageously provides two different functions, a payment function and an identification function. It will also be appreciated that the transportation pass can comprise a collection of elements, i.e., a magnetic card (described above) associated with an electronic tag, or an integral device, e.g., a smart card. Advantageously, the electronic tag can be of the type described in U.S. Pat. Nos. 5,381,137 and 5,798,693, both of which patents are incorporated herein by reference. Alternatively, a suitable smart card can be obtained by modifying the smart card described in U.S. Pat. No. 5,637,848, which is also incorporated herein by reference. In either case, this equipment permits identification of the geographic position of a transportation pass (and consequently of its owner) at any given time with respect to one or more of the receiving devices. Moreover, a series of such receiving devices advantageously can track the transportation pass holder from place to place as he/she goes about his/her daily routine.

One such system advantageously can be constructed from the system disclosed in the above-mentioned U.S. Pat. No. 5,637,848 with very little modification. FIGS. 1, 2, and 3 illustrate various aspects of a transportation pass 1, which can be employed in such a system.

The transportation pass 1 is illustrated in various modes of operation, e.g., during a normal debit operation, during a refusal to operate because the transportation pass is empty, and while being remotely renewed in FIGS. 1, 2, and 3, respectively. It should be noted that the transportation pass 1 also functions to inform the users of buses in an urban network who wish to catch such and such a bus at a given bus stop of a given line of the network, about the real waiting times for the “next buses” expected at the stop in question.

It will be appreciated that transportation passes 1 are provided and made available as transportation passes to users of the mass transit system. It will also be appreciated that transportation passes 1 are suitable for cooperating with a single central station (indicated at 2 in FIG. 3) including a transmitter (indicated at 18 ) designed to generate and emit information signals S cyclically via an electromagnetic path, e.g., a radio frequency (RF) signal. As will be discussed in greater detail below, the signal S advantageously can be employed to provide the passenger(s) with real time, instantaneous positions of respective buses in the mass transit network. It will be appreciated that the signal S advantageously can be generated by a plurality of substations 2a, instead of a single central station 2.

As illustrated in FIGS. 1-3, each transportation pass 1 includes an power source 3, user-actuatable interrogation circuit suitable for identifying each stop at which it is desired to catch a bus, additional circuitry suitable for receiving the signal Sand for selecting therefrom an indication of the expected arrival time of the “next bus” at the predetermined bus stop, circuitry suitable for generating information relating to the waiting times for such next buses at the bus stop, and circuitry including a display screen 4 suitable for displaying such information.

The above-mentioned interrogation, reception, selection, and generating circuitry advantageously can include a receiver antenna 5, a signal processor 6 associated with the antenna for amplification, demodulation, and decoding purposes, control keys 7, and a calculator 8, which preferably includes memory, i.e., a random access memory (ROM) and a read-only memory (ROM). It will be appreciated that several of the discrete circuits advantageously can be incorporated in a dedicated microprocessor of signal processor element.

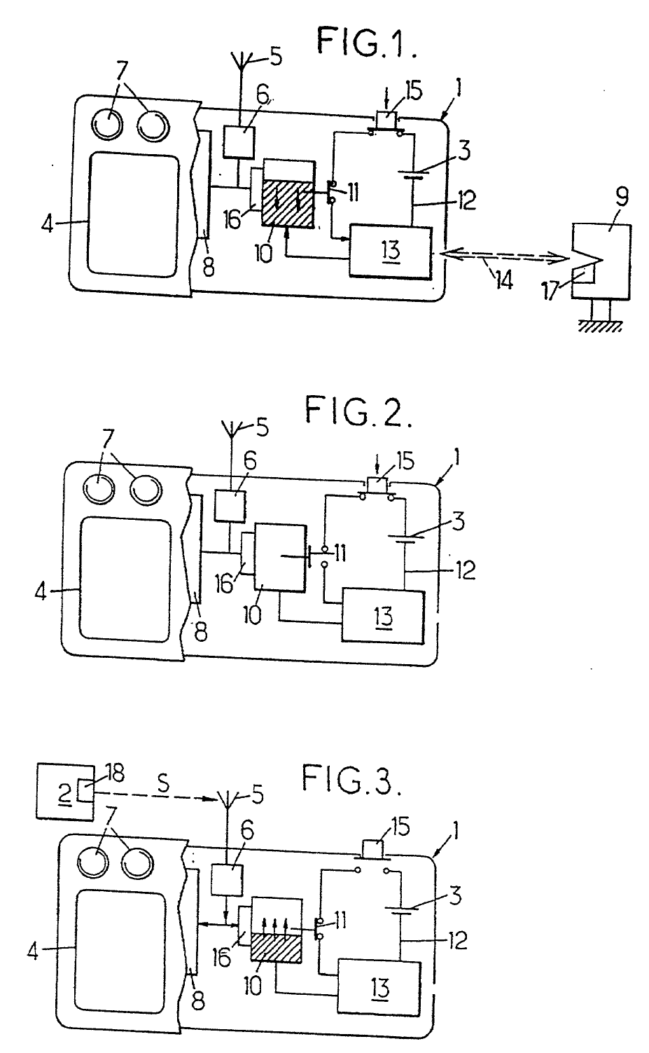

In FIGS. 1 to 3, the box 10 represents a circuit responsive to the validity state of the transportation pass, i.e., the degree of validity of the transportation pass is represented by the shaded area of the box, and the small arrows in or connected with the area show the direction in which the degree of validity is changing for the respective transportation pass. In other words, this degree of validity is decreasing in the example shown in FIG. 1, is zero in the example shown in FIG. 2, and is increasing in the example shown in FIG. 3. Moreover, it is also assumed that the circuit 10 is associated with an electrical switch 11 inserted in the excitation or activation circuit 12 of a transmitter-receiver 13 suitable for cooperating remotely with the sensor unit 9, preferably by means of a radio link, an infrared link, or an acoustic link. The signals interchanged between the sensor units 9 and 13 are represented by double-headed arrows 14 in FIG. 1. Thus, presentation of the, “transportation pass” to circuit 17 of sensor unit 9 advantageously can be carried out remotely.

It should be mentioned at this point that circuit 10 can be electrically coupled to identifier circuit 16, which advantageously stores a code uniquely identifying the transportation pass. It will be appreciated that the unique code stored in identifier circuit 16 advantageously can be transmitted to the unit 9 via the interchange signal 14, in addition to the validity data stored in circuit 10. It should also be mentioned that this coupling distinguishes the device illustrated in FIGS. 1, 2, 3,4A and 4B from the smart card disclosed in the above-mentioned '848 patent

Still referring to FIG. 1, the circuit 10 is connected first to the output of the signal processing circuit 6 via a transportation pass identifier circuit 16 and, second, to the transmitter-receiver 13. The excitation of the actuation circuit 12 is under the control of a pushbutton 15, which projects from the transportation pass and is actuatable by the user. It will be appreciated that the pushbutton may be of use in economizing drain on the power supply 3.

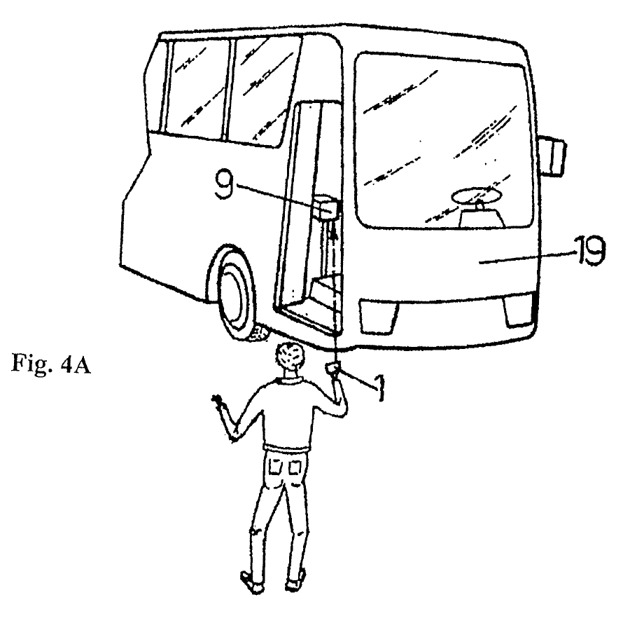

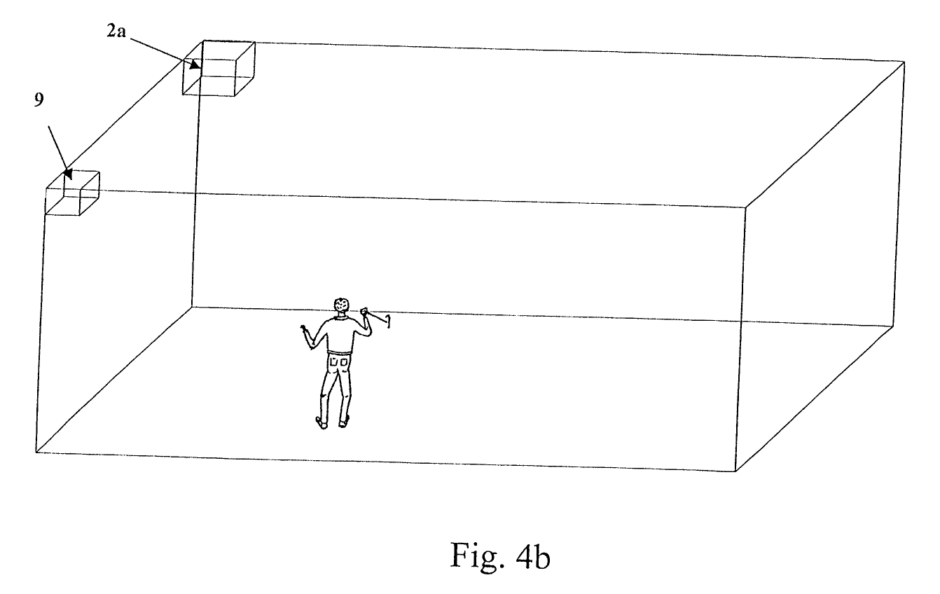

The transportation pass 1 as described above is itself used as a transportation pass, giving access to the buses of the network on being presented in the proximity of a sensor unit 9 for check-in purposes. This is shown in FIG. 4A, wherein a bus of the network is indicated at 19, which carries a sensor unit 9, which unit advantageously includes a circuit 17 responsive to presentation by user of the transportation pass (transportation pass 1). It will be appreciated that the transportation pass advantageously can be employed during both ingress and egress from the bus 19, or other transportation device, when the fares of the mass transit system are established based on distance traveled rather than on a per-use model. Alternatively, as illustrated in FIG. 4B, at least one sensor unit 9 advantageously can be installed in a merchant establishment so that the merchant is able to determine the presence of the transportation pass holder in the establishment. It will be appreciated that the sensor unit need not be deployed in one of the mass transit system or a merchant's establishment; the sensor units advantageously can be deployed in any location where the movement of transportation pass holders is expected to enhance the value of the collected passenger profiles.

The transportation pass's validity state is verified on the basis of one of the following techniques:

(1) the state is defined by an end-of-subscription or “expiration” date F recorded on the transportation pass, in which case it suffices merely to verify that the date on which the transportation pass is “stamped” is earlier than the expiration date F; and

(2) the validity state of the transportation pass is defined by quantifiable data that is recorded or “loaded” in the transportation pass, which data may represent a certain sum of “credit” or a number of authorized trip segments. Under such circumstances, “stamping” of the transportation pass automatically gives rise to reducing the quantifiable data by a quantity that may optionally be related to the length of the trip that the user desires to take on the vehicle in question.

Once the transportation pass 1 is no longer valid, e.g. by its circuit 10 being completely empty or because an expiration date recorded in an appropriate memory of the transportation pass has been passed, the switch 11 opens (FIG. 2) and it is no longer possible to excite the transmitter receiver 13. The transportation pass becomes unusable. It is then possible to reactivate it remotely or to “re-subscribe” by means of the electromagnetic signals S generated by the transmitter 18 of the central station 2 (FIG. 3) providing the user of the transportation pass has prepaid a sum of money corresponding to a new subscription. Such resubscription is performed only after the transportation pass has been correctly identified by a portion of the signals S by comparing them with an encoded identification symbol recorded in the transportation pass identifier circuit 16. This may be physically embodied by actually renewing quantifiable data as defined above into the circuit or store memory 10. It may also be embodied by replacing an expired end-of-subscription date with a new expiration date that is later than the instant at which the replacement takes place.

Regardless of the particular method of reactivation that is adopted, the transportation pass 1 is then again suitable for making individual and successive payments in respect of future bus trips to be taken by the user holding the transportation pass. This will continue until the new subscription under consideration comes to an end.

It will be appreciated that when the sensor units 9 are deployed on buses and other public means of transportation, and each sensor unit 9 is coupled to a respective device which knows the current or next stop of the bus, for example, a customer profile for each person using the mass transit system can be obtained. For example, the above-described central station 2 will receive data in the format illustrated in Table 1.

TABLE 1

| Passenger No. | Entered | Departed |
|---|---|---|
| 001 | Stop 1 | Stop 4 |
| 002 | Stop 1 | Stop 5 |
| 003 | Stop 2 | Stop 5 |

It will be noted that the accumulated information, i.e., the customer profile for passenger No. 1 includes only data on stops visited by passenger No. 1. While this information can be employed in establishing, for example, the number of passengers who left the mass transit system at Stop No. 5 for advertising purposes and the like, the information does not permit resolution of individual customer profiles in order to establish more meaningful demographic data. However, if each passenger wears the respective transportation pass, if the transportation pass transmits a code associated with that passenger, and if all public means of transportation are equipped with the above-mentioned device, a customer profile showing the person's places of interests can be determined. It will be appreciated that by accumulating the data of when the passenger left the mass transport system at one stop and when the passenger subsequently re-enter the mass transit system at either the same or another stop, it is possible to determine how much time a passenger spends in which streets or areas. This data is of interest to both the mass transit system operator and retail stores in the respective town or area.

This, it will be appreciated that it would be possible to encourage passenger willingness to carry a transportation pass with an identification function as well as a payment function by subsidizing the passenger's transportation costs, either directly or indirectly, i.e., all or part of the transportation cost being paid by a company or a set of companies who are interested in the data provided by the identification function.

TABLE 2

| Assume that | | | |
|---|---|---|---|
| instead of | | | |
| accumulating the | | | |
| data indicated in | | | |
| Table 1, the data | | | |
| indicated in Table 2 | | | |
| was accumulated, as | | | |
| indicated | | | |
| immediately below. | | | |
| Table 2 Passenger | | | |
| No. | Profile | Entered | Departed |
| 001 | 3241 | Stop 1 | Stop 4 |
| 002 | 5231 | Stop 1 | Stop 5 |
| 003 | 3241 | Stop 2 | Stop 5 |

Each passenger profile, e.g., profile No. 3241 for passenger No. 1 advantageously can be employed to better resolve the data previously available to the mass transit system operator. For example, the passenger profiles could be employed to break down the data by age, income, education and the like. It should be noted that the information associated with each passenger need not be personal data; information of a general nature could still be employed by companies or merchants in developing highly targeted advertising and in deciding on whether a particular type of store is appropriate to the area. It will be appreciated from Table 2 that the passenger profiles for passenger No. 1 and passenger No. 3 are identical, which simply means that these passengers share many demographic characteristics. Thus, the merchant could pay for detailed information regarding passenger characteristics, such payments being paid to the mass transit system operator to subsidize operation of the mass transit system. It goes without saying that the better the information, the more the mass transit operation can charge for the information, i.e., the greater the indirect subsidies to the passengers at large.

The value of the accumulated passenger profiles to an advertiser or merchant could be greatly enhanced by placing sensor units substantially identical to unit 9 in strategic locations outside of the mass transit system. For example, these units could be deployed in the entrances to fast food restaurants, malls, large department stores, etc. This would allow advertisers to determine how many transportation pass holders entered a particular coffee shop for coffee on their way to the office. The willingness of passengers to use their transportation pass when entering establishments outside of the mass transit system, could be further encouraged by additional, direct transportation subsidies, which can be provided as discussed in greater detail below. In any event, accumulation of passenger profiles indicating travel habits outside of the mass transit system is commensurately more valuable to the advertiser or merchant, which increases the indirect subsidies available to all passengers of the mass transit system.

Even if the sensor units are not employed, passenger profiles could be subjected to additional statistical analysis. For example, the stop data, i.e., the stop at which the passenger exited the mass transit system, can also be evaluated together with other passenger profile data, e.g. gross income per month, the transportation pass holder offered in exchange for the transportation pass to provide assumption on which shops in an area the passenger probably visited.

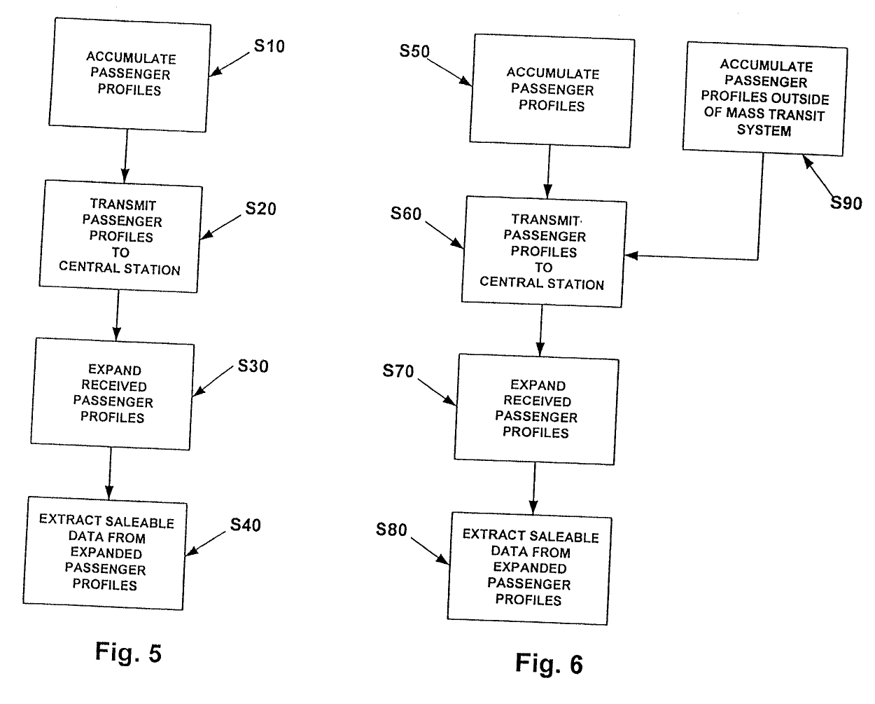

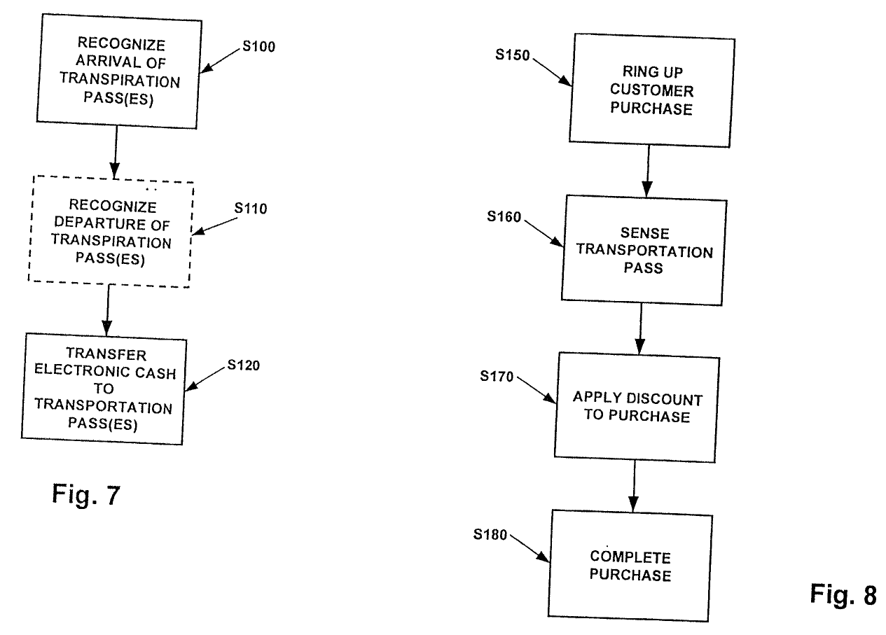

FIGS. 5 and 6 are flowcharts illustrating alternative methods for subsidizing a mass transit system indirectly. FIGS. 7 and 8 are flowcharts illustrating alternative methods for subsidizing passengers of a mass transit system directly. Although the steps performed in FIGS. 5-8 are based on the hardware devices illustrated in FIGS. 1, 2, 3, 4A, and 4B, it will be appreciated that many other components advantageously can be employed to implement the methods according to the present invention. For example, the transportation pass advantageously can be a conventional smart card which is housed in the electronic travel pass disclosed in U.S. Pat. No. 5,734,722, which patent is incorporated herein by reference for all purposes.

Referring to FIG. 5, a method for indirectly subsidizing a mass transit system starts with a step S10 for accumulating passenger profile data, i.e., the data listed in Table 2. It will be appreciated that the transportation cost is implicit in the passenger profile from the stop numbers. It will also be appreciated that this data can be enhanced by including the time and date that the transportation pass holder was at each stop.

Next during step S20, the passenger profile data from each stop in the mass transit system is transmitted to a central station 2, where it is consolidated with passenger profile data from all of the other stops. It should be mentioned that step S20 is optional when each sensor unit 9 is directly connected to the computer facilities at the central station 2. It should also be mentioned that the passenger profiles advantageously can be transmitted to the central station in real time, although this transmission can also be performed in a time delayed manner. Thus, the data from buses advantageously can be retrieved and transmitted to the central station 2 as each bus returns to the garage for servicing and/or maintenance.

During step S30, the passenger profile data is expanded to convert the identification code contained in the passenger profile into field data, which is more easily sorted. Moreover, the data implicit from the passenger profile data, i.e., an indication that the passenger is a rush hour passenger, advantageously can be added back to the passenger profile in creating the expanded passenger profile. Finally, during step S40, the expanded passenger profile data is mined for commercially useful data, i.e., demographic data that can be sold to an advertiser or merchant. For example, saleable data could be generated to help a merchant decide whether to expand an existing shop or open an additional shop to capture customers who frequent a stop which is too far away from the merchant's existing shop. Thus, the demographic data extracted from the passenger profiles is sold to the merchant, with the proceeds of the sale being applied to offset mass transit system operating cost, i.e., the proceeds of the sale forming an indirect subsidy to the passengers at large of the mass transit system.

In the exemplary embodiment depicted in FIG. 2, the profile associated with each passenger is collected along with data noting the passenger's entrance and egress to the mass transit system. However, it will be appreciated that a unique customer number can be collected with the entrance and egress data. In that case, the generation of the expanded passenger profile would involve looking up the profile corresponding to that unique customer number in a look up table and replacing the customer number with the corresponding profile.

FIG. 6 illustrates another method for indirectly subsidizing a mass transit system, which includes steps S50, S60, S70, S80, and S90 step. It will appreciated from a comparison of FIGS. 5 and 6 that the inclusion of step S90 in the inventive method is the most substantial difference between the methods of FIG. 5 and FIG. 6. However, it will be appreciated that the addition of step S90, whereby passenger profile data is accumulated even while the transportation pass holder is outside of the mass transit system permits the system operator to add significant value to the reports generated from data mining operations. For example, a merchant should be willing to pay an additional amount to learn which of the, for example, three routes to a department store the majority of the transportation pass holders use in getting to that department store, since the merchant could then place targeted advertising along that particular route. An increase in sales price for demographic data generated by data mining should translate directly into increased indirect subsidies to the transportation pass holders, i.e., the mass transit system passengers.

Referring now to FIG. 7, a method for directly subsidizing individual passengers of a mass transit system starts with the step S100 of recognizing the arrival of a transportation pass holder in, for example, a department store. This advantageously could be accomplished by providing special VIP entrances operated by the transportation pass or by deploying sensor units at strategic locations in the department store. During optional step S110, the sensor units 9 are employed to determine that a transportation pass holder is leaving the store. During step S120, electronic cash is transferred to either the transportation pass itself or an account linked to the transportation pass to reward the store's patron by subsidizing his/her transportation cost to the department store.

It will be appreciated that step 110 is optional, since the transportation pass holder need not leave the store in order to be rewarded for browsing. For example, a low power station 2asimilar to station 2 of FIG. 3 advantageously can be instructed to add a predetermined amount to all of the transportation passes on the premises at predetermined times, e.g., every fifteen minutes. It will be appreciated that the predetermined amount can be varied to subsidize the transportation costs of transportation pass holders by a greater amount during times when there are traditionally few customers in the store.

Referring now to FIG. 8, a complementary method of directly subsidizing the transportation costs of mass transit system passengers start with a step S150, when the transportation pass holder arrivers at the check out station to pay for his/her selection and the cashier rings up the purchase. During step S160, a sensor unit 9 at the check out station senses the transportation pass. During step S170, a discount is applied to the customer's total bill and, during S180, the customer completes his/her transaction. It will be appreciated that, in this case, the transportation pass acts as a discount coupon for the transportation pass holder and, thus, the transportation cost to the merchant's establishment can be directly subsidized by the merchant. It will also be noted that the subsidy, i.e., discount, advantageously can be varied to encourage store patronage at time when the store is relatively vacant.

Thus, the transportation pass advantageously can be employed as a coupon in merchant establishments, which provides the passenger with a direct subsidy. For example, in an effort to attract new customers to a restaurant, the restaurant could decide to reward transportation pass holders with a discount on a meal or a particular item on the menu. Mass transit system passengers not possessing a transportation pass would not be offered this subsidy. Alternatively, the transportation pass also serves as an area specific electronic purse, i.e., the transportation pass can be used for both public transportation and for shopping in a certain area. For example, when the transportation pass is used to make a purchase in a particular shopping district or store, the “cash” in the electronic purse could be subsidized, i.e., $98.00 transportation pass dollars could be used to make a $100 dollar cash purchase. It should be mentioned that the feature could be employed to provide further incentives to customer to arrive via the mass transit system instead of another mode of transportation when the municipality offers to discount local sales taxes charged to the transportation pass.

Alternatively, an additional direct subsidy can be provided mass transit system passengers. More specifically, from the time a transportation pass holder leaves, for example, a bus to spend some time in a shopping area until he/she reenters the mass transit system, value, e.g. electronic money, is transferred to the electronic purse, i.e., the transportation pass. For example, the transportation pass hold can use his/her transportation pass to enter and leave a particular department store. Electronic money advantageously could be added to the transportation pass based on the amount of time the transportation pass holder spent in the department store. Alternatively, each department in the department could be equipped with a substation 2a, which could broadcast an “electronic money” signal to all transportation pass holders who happen to be in the department store at a particular time. Stated another way, the department store transmits electronic money every fifteen minutes to all transportation pass holder who happen to be in the department store at that particular time, thus encouraging passengers to browse that particular department store. Thus, the inventive method according to the present invention can be used to influence the shopping behavior of the participating transportation pass holder. If a transportation pass holder is rewarded for staying at a certain place for a while and then e.g. reentering mass transit system at the same place or anther “allowed” place, he/she is likely to visit the shops in the respective area.

It should be mentioned that the methods for subsidizing the operation of a mass transit system described with respect to FIGS. 6-8 are not mutually exclusive. Any or all of these methods advantageously can be implemented at any given time. For example, the method depicted in FIG. 6 can be employed to continuously track transportation pass holders while the mass transit system is in operation but the methods of FIG. 7 and/or FIG. 8 can be selectively employed to subsidize only weekend, or early morning, or late evening shopping.

It will be appreciated that the inventive method according to the present invention brings together existing technologies to pursue an innovative business idea. Advantageously, the service could be provided by a third party who functions as broker between the participating shops, the mass transit system operator, and the participating transportation pass holders.

It will also be appreciated that the infrastructure needed to perform the inventive methods according to the present invention can be provided in alternative ways. For example, the passenger profile data advantageously can be transmitted online per radio connection to one or several collectors and then passed on to a data center. Alternatively, the passenger profile data can be written on a local storage medium, e.g., a disc, a tape, etc., on each bus or in each participating merchant, and forwarded once per day and brought to the data center. At the data center, a well known computer system advantageously can be employed to “mine” the accumulated passenger profile data for commercially significant data which can be sold to advertisers or merchants.

Moreover, when the transportation pass functions as an electronic purse, loading terminals located at participating shops advantageously can be used to load the transportation passes with electronic money. It will be appreciated that, alternatively, the balance associated with the transportation pass can be maintained at the data center and retrieved from each terminal. In that case, no electronic money loading and storage function need be associated with the transportation pass; the transportation pass would merely provide the mass transit system with a payment authorization code (payment function) and an identification code (identification function). Preferably, two separate codes are employed to so that the mass transit system operator avoids the temptation for sell personal information about transportation pass holders, e.g., sell a mailing list with the names and addresses of all transportation pass holders.

What has been explained above with respect to shops and retailers also applies to, e.g., restaurants, movie theaters, taxi or shuttle services, parking spaces, etc. It will be appreciated that a fully automated electronic or electromagnetic or magnetic interaction with the card or pass greatly facilitates the usage thereof, in terms of time spent and effort made to validate and use the pass or card.

The term “validating” includes, but is not limited to, “setting the electronic value or legal tender” and “making valid or suitable for the intended purpose” and “contributing to making valid or suitable for the intended purpose”.

Although presently preferred embodiments of the present invention have been described in detail herein above, it should be clearly understood that many variations and/or modifications of the basic inventive concepts herein taught, which may appear to those skilled in the pertinent art, will still fall within the spirit and scope of the present invention, as defined in the appended claims.

What is claimed is:

1. A method of enabling a person to use a mass transport system wherein a passenger uses a transportation pass, the method comprising validating the pass for conducting a commercial transaction outside the system.

2. The method of claim 1, wherein the pass gets validated electronically.

3. The method of claim 1, wherein the validating comprises modifying an amount of electronic money.

4. The method of claim 1, wherein the pass is validated for the transaction restricted to a predetermined geographic vicinity of the system.

5. The method of claim 1, wherein the validation relates to enabling to receive a discount in the transaction.

6. The method of claim 1, wherein the validation relates to reducing a fare for the system.

7. The method of claim 1, wherein the pass gets validated for conducting the transaction during a limited time period.

8. The method of claim 1, wherein:
the pass gets validated for conducting a respective commercial transaction during a respective pre-determined time period.

9. The method of claim 1, comprising monitoring the pass entering and exiting the system for profiling the passenger.

10. A method of enabling a person to conduct a commercial transaction with an electronic card, the method comprising validating the card upon completion of the transaction conducted outside a mass transport system for enabling the person to use the card as a transportation pass in the system.

11. The method of claim 10, wherein the pass gets validated electronically.

12. The method of claim 10, wherein the validation comprises modifying an amount of electronic money.

13. An electronic card for use both as transportation pass in a mass transport system and for conducting a commercial transaction outside the system.

14. The card of claim 13, for being validated by the system for the transaction.

15. The card of claim 13, for being validated for use as the transportation pass upon the transaction.

16. The card of claim 15, for being validated to receive a discount on a fare upon completion of the transaction.

17. A method of controlling an infrastructure of a geographic area wherein passengers use a mass transport system, the method comprising:
monitoring transportation passes interacting with the system; and
based on the monitoring providing incentives for the passengers to conduct a commercial transaction outside the system using the transportation passes as tender.

18. The method of claim 17, comprising creating a profile of a flow of passengers through the system.
